(19) United States
(12) Patent Application Publication
(10) Pub. No.: US 2006/0189183 A1
(43) Pub. Date: Aug. 24, 2006

(54) Camera module connector

(76) Inventor: Ming-Hsun Yang, Taipei (TW)

Correspondence Address: MOLEX INCORPORATED, 2222 WELLINGTON COURT, LISLE, IL, 60532, US

(21) Appl. No.: 11/356,941

(22) Filed: Feb. 17, 2006

(30) Foreign Application Priority Data
Feb. 18, 2005 (TW) 94202701

(51) Int. Cl. H01R 13/648

(52) U.S. Cl. 439/95

(57) ABSTRACT

A camera module connector assembly includes a connector and a camera module. The connector includes an insulative housing that defines a hollow receiving space therein, a plurality of signal terminals fixed in the housing, a shield surrounding the housing, and at least one grounding pin. The camera module is disposed in the receiving space and has a substrate formed with contact pads. One end of each of the terminals respectively contact the substrate contact pads, so that the camera module is electrically connected to the connector. A metal layer is coated on the main body of the camera module, which provides a shielding function to the camera module and the connector, to protect the present invention from EMI for a better shielding result. The camera module assembly is manufactured more easily for reducing manpower and time, thereby the assembling cost is also reduced.

### BACKGROUND OF THE INVENTION

The present invention relates to a camera module connector, and more particularly, to a camera module connector having an electrical connector for receiving a camera module therein to make the camera module electrically connect with a circuit board, and wherein the camera moduoe has a grounding aspect integrated therewith.

Because of the development of wireless communication and the rapid revolution in high technology, portable electronic products, such as mobile phones, PDAs and Tablet PCs, are assembled with different electronic additional-modules such as camera modules for taking pictures and satisfying desires of consumers.

Reference is now made to FIGS. 1 and 2, which illustrate a conventional camera module connector including an electrical connector 6 and a camera module 7. The electrical connector 6 is mounted on a circuit board 8 for accommodating the camera module 7.

The electrical connector 6 includes an insulative casing 61, a plurality of signal terminals 62 and a metallic housing 63. The insulative casing 61 forms a receiving space therein that receives the camera module 7. The signal terminals 62 are fixed respectively on four side walls of the insulative casing 61. A metallic housing 63 sheathes and wraps the insulative casing 61 and is shown as installed from outside of the connector.

Ends of the signal terminals 62 abut against contact pads 81 of the circuit board 8 correspondingly, so that the connector 6 is electrically connected to the circuit board 8. The camera module 7 is disposed in the inner space of the insulative casing 61 of the connector 6. The other ends of the signal terminals 62 abut against contact pads on the exterior surfaces of the module 7, so that the module 7 is electrically connected to the connector 6 and it is also electrically connected to the circuit board 8 through the connector 6.

The main body 71 of the foresaid camera module 7 is made of plastic, whose shielding properties are weak. For providing better shielding, a metallic shielding housing 9 is usually added to cover the camera module 7 and the electrical connector 6. The shielding housing 9 wraps around the camera module 7 and the electrical connector 6 from above, so it can be protected from EMI for a better shielding protective effectiveness.

However, the conventional camera module connector uses the shielding housing 9, which requires a metallic material and through punching and bending processes. The manufacturing of the shielding housing 9 is quite inconvenient, and the finished shielding housing 9 requires further assembling with the camera module 7 and the electrical connector 6. The assembly thereof requires much time and work, so it is difficult to reduce costs. Moreover, the shielding housing 9 is assembled on the camera module 7 and the electrical connector 6, which also increases the entire size and is difficult to fulfill the smaller-size requirements of new, then and light electronic products.

The present invention is therfore directed to a camera module connector that improves upon the aforesaid disadvantages and which dispenses with the need for a separate exterior shield fixed to the camera module housing.

### SUMMARY OF THE INVENTION

It is therefore a general object of the present invention to provide a camera module connector, which can provide shielding for a camera module and an electrical connector with a better shielding and protective effect and a method of manufacture that is easier and reduces the need for manpower and lessens assembly time to reduce costs effectively, and is also slim and light.

Another object of the present invention is to provide an improved camrea module and connector assembly, wherein the exterior surfaces of the camera module are plated with a conductive material so as to provide shielding to the camera module, and wherein the connector is configured to receive the module therein.

Yet another object of the present invention is to provide a camera module connector assembly utilizing a connector with an insulative housing in the form of a hollow rectangle or square, the housing suporting a plurality of first conductive terminals for connecting with traces on a circuit board, the assembly including a condutive shield member surrounding the housing and including a plurality of second conductive terminals, a camera module that is insertable into the hollow housing, the camera module having contacts that touch the first terminals when the camrea module is inserted into the housing, and the camera module having a conductive exterior applied thereto, as in the manner of conductive plating, the plating touching the second terminals when the camera module is inserted into the housing.

Still another object of the presnet ivention is to provide a camera module connector assembly as described above, where the second terminals are arranged proximate to corners of the camera module.

In order to achieve the above objects, the present invention provides a camera module connector comprising an electrical connector and a camera module. The electrical connector includes an insulative housing, a plurality of signal terminals, a metallic housing and at least one grounding pin. The insulative housing has a bottom wall, four side walls and a receiving space formed between the bottom wall and the four walls. The four side walls are formed with a plurality of terminal grooves for respectively receiving a single signal terminal therein. Each of the signal terminals has a contact end that extends into the receiving space and a tail end that extends outside the insulative housing. The grounding pin is located at one side of the receiving space and has one end extending into the receiving space. A metallic housing surrounds the insulative casing. The camera module has a main body and a substrate. The main body has a module base and a lens portion. The lens portion connects to a top surface of the module base. A top surface of the substrate connects to a bottom surface of the module base of the main body. The substrate has a plurality of contact pads disposed at four sides thereof. The camera module is coated with a metal layer on its four exterior sides and a top surface of the module base of the main body. The camera module is received in the receiving space of the housing of the connector. The contact ends of the signal terminals respectively contact with contact pads on the camera module, and the grounding pin has one end contacting with the exterior conductive layer on the camera module.

The present invention is coated with a conductive layer, preferably a metal plating, on the main body of the camera module, so that it provides shielding to the camera module and the electrical connector for protection from EMI. The metal layer is coated on the main body of the camera module. Thus, the camera module connector assembly may manufactured more simply and less labor and time is required during assembly to thereby reduce its cost. Moreover, the metal layer is coated on the main body of the camera module, and the total size is not increased much at all.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a perspective view of a known camera module connector assembled with an outer shielding housing, with the module moved away slightly from its connector;

FIG. 2 is the same view as FIG. 1, but in an assembled condition;

FIG. 3 is an exploded perspective view of a camera module and connector constructed in accordance with the principles of the present invention;

FIG. 4 is the same view as FIG. 3, but in an assembled condition;

FIG. 5 is a top plan view of the camera module connector of FIG. 3;

FIG. 6 is a cross-sectional view of FIG. 5, taken along line 6-6 thereof;

FIG. 7 is a cross-sectional view of FIG. 5, taken along line 7-7 thereof;

FIG. 8 is an exploded perspective view of the connector of FIG. 3; and,

FIG. 9 is an exploded perspective view of another embodiment of the electrical connector of FIG. 3.

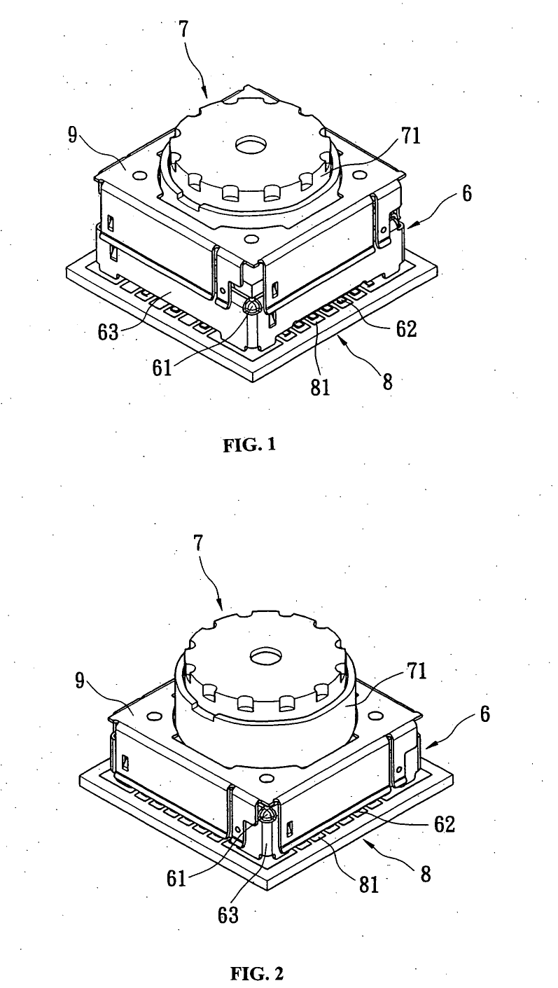

### DETAILED DESCRIPTION OF THE PREFERRED EMBODIMENTS

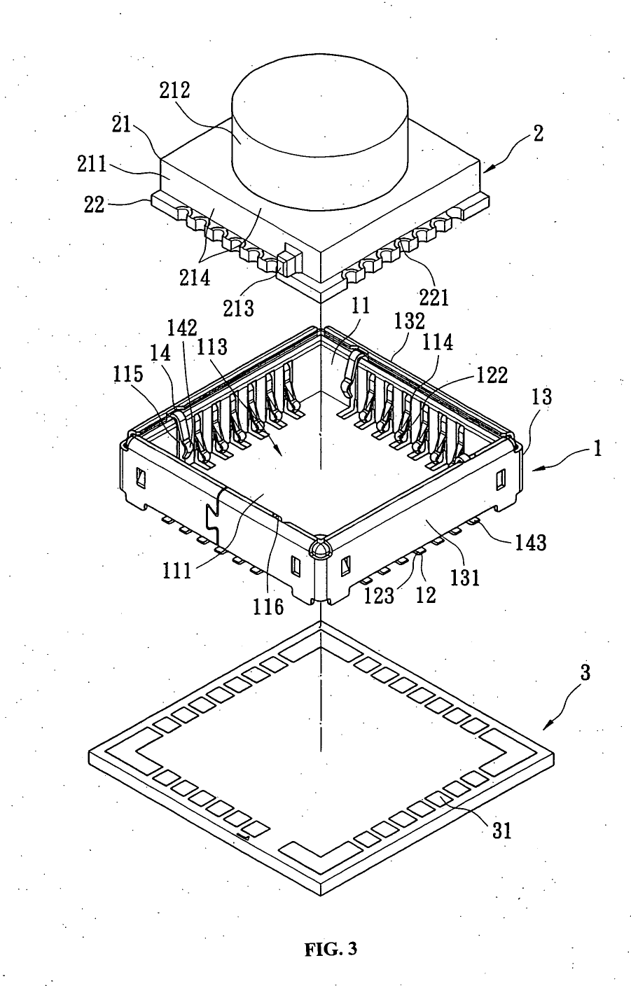

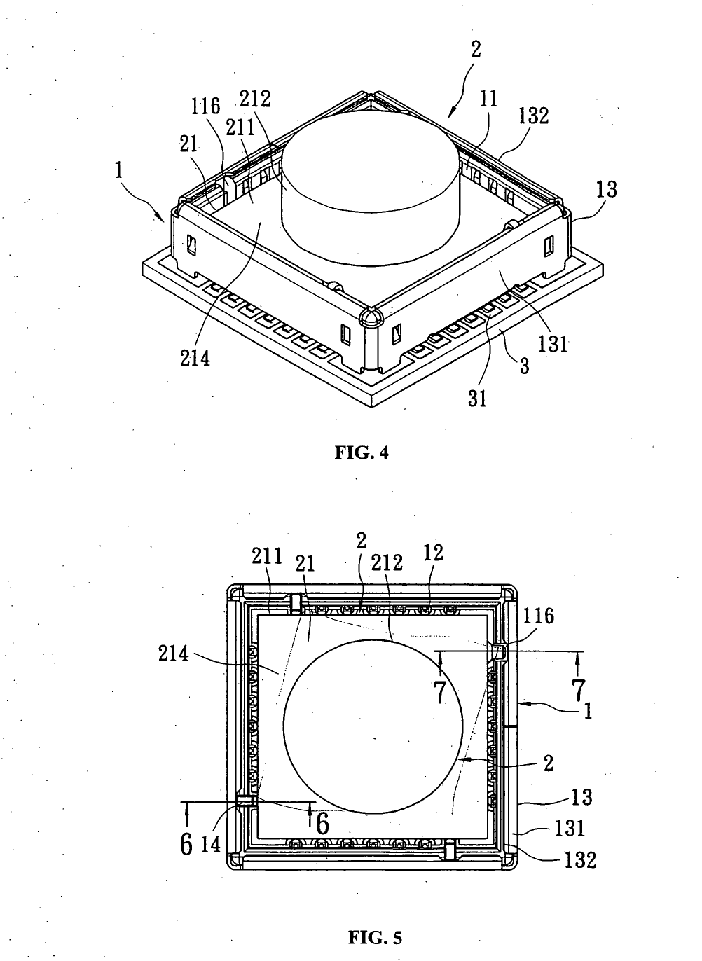

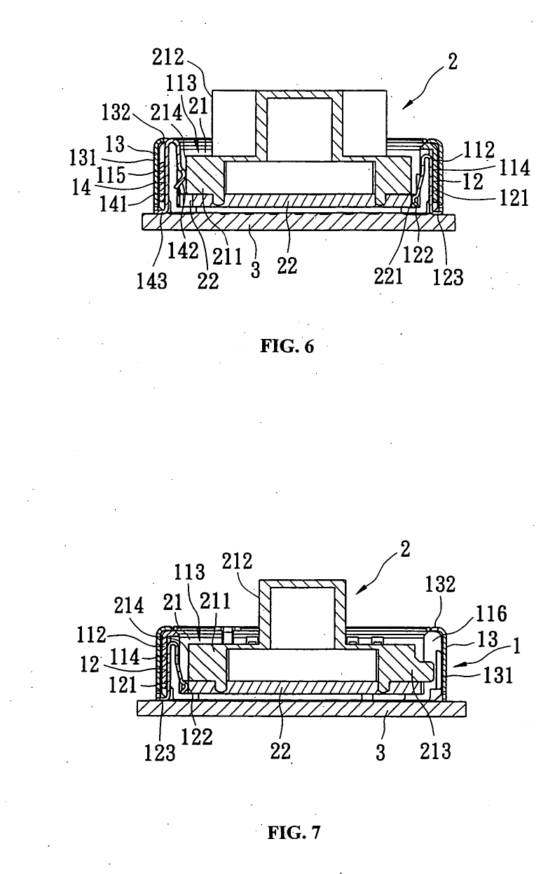

Referring to FIGS. 3 to 7, it can be seen that the present invention provides a camera module connector, which includes an electrical connector 1 and a camera module 2. The electrical connector 1 is mounted on a circuit board 3 for receiving the camera module 2 therein.

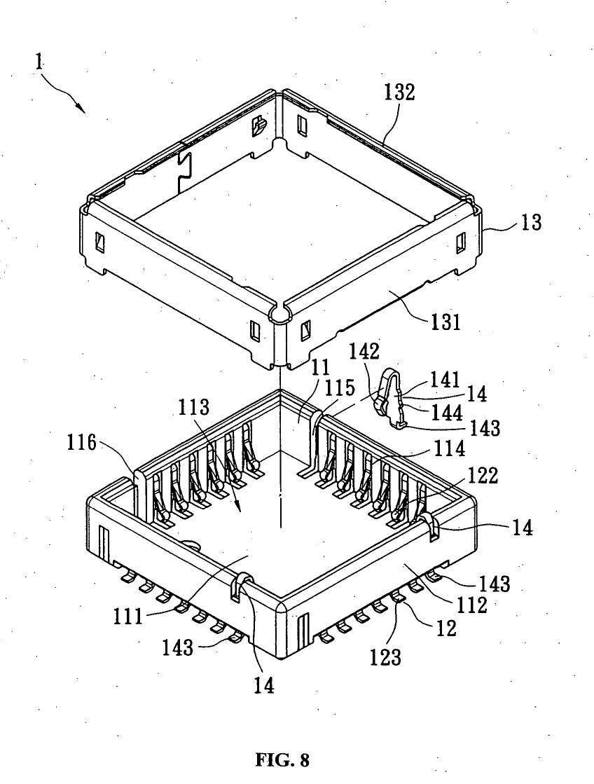

The electrical connector 1 includes an insulative housing 11, a plurality of conductive signal terminals 12 supported therein, a conductive metallic or metal housing 13 and at least one grounding pin 14. The housing 11 is made of plastic and has a bottom wall 111 and four side walls 112 formed integrally with the bottom wall 111 (as shown in FIG. 8). A receiving space 113 is formed between the bottom wall 111 and the four side walls 112 of the housing 11. The four side walls 112 of the housing 11 are formed with a plurality of terminal-receiving grooves or cavities 114. The grooves 114 penetrate through an outside edge connecting the side walls 112 and the bottom wall 111. The terminal grooves 114 also extend upward along an inner surface of the side walls 112. The side walls 112 of the housing 11 further include at least one grounding-pin groove 115 therein. In this embodiment, the side walls 112 form three grounding-pin grooves 115, respectively. The housing 11 also includes a cutout 116 on one of the side walls 112.

The signal terminals 12 are made of a conductive and elastic material, and they each include a main portion 121, a contact portion 122 extending from one end of the main portion 121 and a solder tail portion 123 extending from the other end of the main portion 121, respectively. The main portions 121 of the signal terminals 12 are fixed, and preferably embedded in the side wall grooves 114 of the housing 11 respectively, so that the signal terminals 12 are assembled in the housing 11. Each terminal contact portion 122 of the signal terminals 12 extends elastically into the receiving space 113, while each terminal solder tail portion 123 extends beyond a bottom surface of the housing 11. The terminal solder tail portions 123 may be soldered to corresponding contact pads 31 on the circuit board 3 in order to electrically connect the connector 1 with the circuit board 3.

The grounding pins 14 are also made of a conductive, elastic metallic material or a metal, and each of them includes a main portion 141, a contact portion 142 and a solder tail portion 143 extending from two ends of the main portion 141, respectively. The main portions 141 of the grounding pins 14 are fixedly in the grounding-pin grooves 115 of the housing 11 in the same manner as the signal terminals. The main portions 141 are formed with interfering portions 144 on two sides thereof, thereby the interfering portions 144 bite into the inner walls of the grounding-pin grooves 115 so that the grounding pins 14 can be firmly assembled in the housing 11. The grounding pins 14 are mounted on the housing 11, and are located at one side of the receiving space 113. The contact portions 142 of the grounding pins 14 extend inwardly from the housing 11 and extend elastically into the receiving space 113. Each of the solder tail portions 143 of the grounding pins 14 extend beyond a bottom surface of the insulative casing 11. The solder tail portions 143 of the grounding pins 14 can be soldered with the corresponding contact pads 31 of the circuit board 3, so that the connector 1 is grounded to the circuit board 3. The grounding pin grooves 115 ar ealigned with the contect portions 142 thereof so that the grooves receive portions of the grounding pin grooves when the camera module is inserted into the receiving sapce and the camera module presses against the grounding pins.

The outer metallic shield 13 has four side plates 131 connected to each other to form a hollow square or rectangle. The side plates 131 have rim portions 132 that extend along upper edges thereof. The shield 13 is applied to the housing in the downward direction, over the side walls of the housing 11 and is fixed around the periphery of the housing 11. The rim portions 132 on the upper edge of the sheild 13 wholly press against a top portion of the housing 11, and the housing 11 is covered beneath the sheild 13. The solder tail portions 123 of the signal terminals 12 and the solder tail portion 143 of the grounding pin 14 are soldered to the corresponding contact pads 31 of the circuit board 3, so that the connector 1 is electrically connected to the circuit board 3.

The camera module 2 includes a main body 21 and a substrate (printed circuit substrate) 22. The main body 21 has a base 211 that is square or rectagularly-shaped and a lens portion 212 that is cylindrical in shape. The lens portion 212 connects to a top surface of the base 211 and the base 211 includes a protrusion 213 thereon that corresponds to the cutout 116. The camera module 2 is plated with a metal layer 214 on its exterior surface which at least prefrably covers four sides and a top surface of the base 211 of the module main body 21. The metal layer 214 is conductive so that it offers protection from electromagnetic interference (EMI). A periphery of the lens portion 212 of the main body 21 may or may not have plating on it. The top surface of the substrate 22 connects to the bottom surface of the base 211 of the module main body 21. The substrate 22 forms a plurality of contact pads 221 at four sides thereof, respectively. The contact pads 221 are concaved from four sides of the substrate 22 separately.

The camera module 2 fits into the receiving space 113 formed in the housing 11 of the connector 1. The contact portions 122 of the signal terminals 12 that are received in the side walls 112 of the housing 11, therefore press against and contact the contact pads 221 at four sides of the camera module substrate 22 in a lateral direction. The camera module 2 can connect to the connector 1, and then the camera module 2 can connect to the circuit board 3 through the connector 1.

When the camera module 2 is disposed in the receiving space 113 of the housing 11 of the connector 1 the present invention provides an anti-disorientation function via the protrusion 213 on the module base 211 of the main body 21 of the camera module 2 cooperating with the cutout 116 on the side wall 112 of the housing 11. It prevents the camera module 2 from being inserted in a wrong direction with an orientating property, when the camera module 2 is disposed into the receiving space 113.

The grounding pins can be seen to be located proximate to the interior corners of the receiving space, and the ground pins are further arranged so that grounding pin on opposing surfaces are offset with each other as shown in FIG. 5. If imaginary lines were drawn to interconnect the ground pins, an angled square or rectangle would be inscribed within the housing receiving space. This is shown by the dashed lines in FIG. 5.

Moreover, after the camera module 2 is disposed in the receiving space 113 of the housing 11 of the connector 1, the contact portions 142 of the grounding pins 14 press against and contact the metal layer 214 on the module base 211 of the main body 21 of the camera module 2, so that the camera module 2 and the connector 1 are grounded. Through the above-mentioned structure, the camera module connector of the present invention is accomplished.

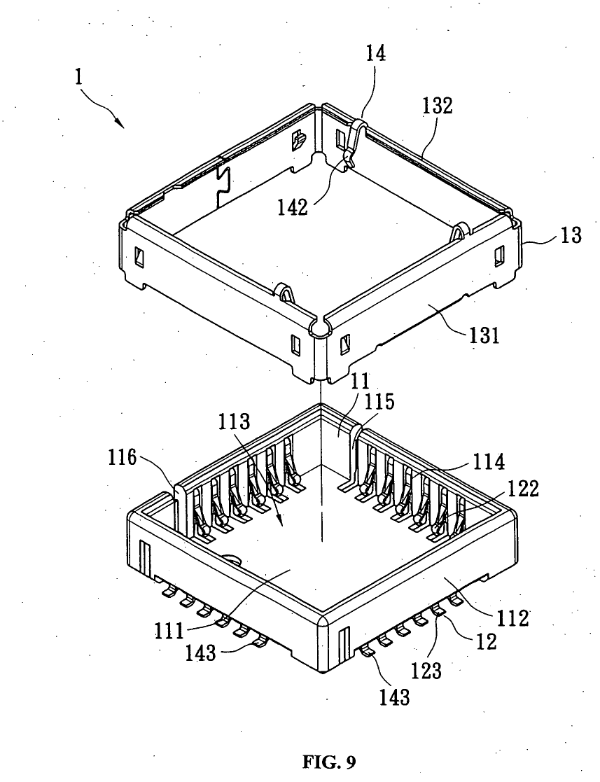

In addition, in an alternative embodiment, such as is shown in FIG. 9, the grounding pins 14 are formed integrally with the shield 13 as one piece, i.e. the grounding pins 14 extend downwardly from the upper edge of the side plates 131 of the metallic housing 13. The grounding pins 14 each respectively include a contact portion 142, and the contact portions 142 extend elastically into the receiving space 113 of the housing 11.

The present invention skillfully uses the main body 21 of the camera module 2 that is plated with the metal layer 214. The metal layer 214 therefore provides the camera module 2 and the connector 1 with shielding and protection from EMI. The metal layer 214 of the present invention is plated directly on the exterior surfaces of the module main body 21. The shield does not need punching and bending processes as per conventional techniques, so that the present invention makes the manufacture of the camera module connector easier, the required manpower and time of assembling are therefore more economical, and costs are reduced. In addition, the present invention plates the metal layer 214 on the main body 21 of the camera module 2, so that the entire size will not increase too much, thereby fulfilling the requirements of being thin and light.

While the preferred embodiment of the invention have been shown and described, it will be apparent to those skilled in the art that changes and modifications may be made therein without departing from the spirit of the invention, the scope of which is defined by the appended claims.

What is claimed is:

1. A camera module connector assembly, comprising:
a connector, the connector including an insulative housing and a plurality of conductive terminals disposed in the housing, a shield and at least one grounding pin, said housing including a bottom wall, four side walls and a receiving space cooperatively defined by the bottom and four side walls, said four side walls including a plurality of terminal grooves dispopsed therein, each groove respectively receiving a single one of said terminals therein, each of said terminals including a contact end extending into said receiving space and a tail end extending outside said housing, the grounding pin being disposed along at least one side of said receiving space and having a contact end extending into said receiving space; and,
a camera module, having a body portion and a substrate, said body portion including a base portion and a lens portion, the lens portion extending from a top surface of said base portion, a top surface of said substrate connecting to a bottom surface of said base portion, said substrate having a plurality of contact pads disposed thereon, said camera module including a metal layer disposed on at least four sides and a top surface of said base to provide shielding to said main body;
whereby when said camera module is disposed in said receiving space of said housing, said terminal contect ends in said receiving space respectively contact said camera module contact pads, and said grounding pin contact end contacts said metal layer of said camera module.

2. The connector assembly claimed in claim 1, wherein said side walls of said housing include at least one grounding-pin groove, said grounding pin including a main portion, a contact portion extending from one end of said main portion and a solder tail portion extending from another end of said main portion, said main portion of said grounding pin being received with the grounding-pin groove of said housing, said contact portion of said grounding pin extending into said receiving space, said solder tail portion of said grounding pin extending outside said housing.

3. The connector assembly claimed in claim 1, wherein said grounding pin is integrally formed with said sheild, and said grounding pin extends into said receiving space from said sheild, said grounding pin including a contact portion extending into said receiving space.

4. The connector assembly claimed in claim 1, wherein said shield has four side plates connecting to each other, the said side plates each including a rim portion extending along an upper edge thereof and abutting against top edges of said housing.

5. The connector claimed in claim 3, wherein said housing includes a grounding pin groove aligned with said shield ground pin, whereby the grounding pin groove receives a portion of said grounding pin when said camera module is inserted into said receiving space.

6. The connector claimed in claim 1, further including four grounding pins, each of the grounding pins being disposed proximate to interior corners of said receiving space.

7. The connector claimed in claim 6, wherein said four grounding pin are arranged such that grounding pins on opposite sides of said housing are offset from each other.

8. The connector claimed in claim 7, wherein imanginary lines drawn interconnecting said grounding pins together circumscribes a four-sided polygon within said receiving space.
